(19) United States
(12) Patent Application Publication
(10) Pub. No.: US 2015/0170225 A1
(43) Pub. Date: Jun. 18, 2015

(54) COLLABORATIVE PLATFORM SYSTEM FOR LIVE ENTERTAINING

(71) Applicant: Jean Élie Belleroche, Hockessin, DE (US)

(72) Inventor: Jean Élie Belleroche, Hockessin, DE (US)

(21) Appl. No.: 14/554,527

(22) Filed: Nov. 26, 2014

Related U.S. Application Data
(60) Provisional application No. 61/917,510, filed on Dec. 18, 2013.

(51) Int. Cl. G06Q 30/02; H04L 29/08; G06Q 50/00; G06F 21/10

(52) U.S. Cl. CPC G06Q 30/0277; G06F 21/105; H04L 67/10; G06Q 50/01

(57) ABSTRACT

A method of collaboratively promoting and consuming a plurality of multimedia content is provided. The method may embrace and promote easy access to new releases (New Movies/Films, music, games, videos, sportive events, etc.) to everyone, everywhere, anytime (whenever) through the use of all kinds of possible channels (digital methods) of distribution. This method may comprise a one-world platform configured to provide access to the plurality of multimedia content to a plurality of users having a profile, wherein the plurality of multimedia content may be accessed through at least one of a purchase and a subscription; providing a Bellgoo platform connected to the one-world platform, wherein the Bellgoo platform is configured to provide group interactions through multiple interaction configurable modalities; providing an anti-piracy module configured to prevent the distribution of pirated content over the one-world platform; simultaneously consuming a predetermined portion of the plurality of multimedia content over the one-world platform on the part of the plurality of users, whereby scheduling of group view by the plurality of user is promoted; and sharing commentary on the predetermined portion of the plurality of multimedia content part over the Bellgoo platform on the part of the plurality of Local, Mixed and Global group users.

### CROSS-REFERENCE TO RELATED APPLICATION

This application claims the benefit of priority of U.S. provisional application No. 61/917,510, filed 18 Dec. 2013 the contents of which are herein incorporated by reference.

### BACKGROUND OF THE INVENTION

The present invention relates to user interaction on an online platform and, more particularly, to enabling collaborative consumption and communication of multimedia content sharing by users of the online platform.

Although online communities and social network services currently enable different levels of participation among and between users to interact across various geographical boundaries, the interactions are discrete—for example, members adding comments or tags on a blog site, posting messages on a message board, utilizing discrete email and chat services, etc. Such discrete interaction constrict participant feedback, total user exposure and the overall exchange of ideas, and so limits both the cultural impact and the entertainment industries' market penetration. Likewise, such online communities and social network are discretely packaged to similarly situated users, further restricting the scope of simultaneously collaborations among users.

Moreover, current mass media distribution methods require people to leave their homes or respective locations in order to consume new forms of entertainment, such as new movies, and so users cannot engage in cooperative and interactive participation of these new forms of entertainment.

As can be seen, there is a need for a system that allows users to collaboratively view live, new and recorded multimedia content from multiple sources while simultaneously allowing those users and/or participants of such content to interact with its end-consumers. Moreover, there is a need to provide access to instantaneous and incessant new-release entertainment to everyone, anytime, everywhere alleviating the consumers' need not leave their current residence or location to enjoy such entertainment, either individually or collectively.

### SUMMARY OF THE INVENTION

In one aspect of the present invention, a method of collaboratively promoting and consuming a plurality of multimedia content comprises: providing a one-world platform configured to provide access to the plurality of multimedia content to a plurality of users having a profile, wherein the plurality of multimedia content may be accessed through at least one of a purchase and a subscription; providing a Bellgoo platform connected to the one-world platform, wherein the Bellgoo platform is configured to provide group interactions through multiple interaction configurable modalities; providing an anti-piracy module configured to prevent the distribution, streaming and viewing of unsubscribed and pirated content over the one-world platform; simultaneously consuming a predetermined portion of the plurality of multimedia content over the one-world platform on the part of the plurality of users, whereby scheduling of group view by the plurality of user is promoted; and sharing commentary on the predetermined portion of the plurality of multimedia content part over the Bellgoo platform on the part of the plurality of users.

In another aspect of the present invention, a system for collaboratively promoting and consuming a plurality of multimedia content, comprises: a computer having a user interface; and a program product comprising machine-readable program code for causing, when executed, the computer to perform the following process steps: providing a one-world platform configured to provide access to the plurality of multimedia content to a plurality of users having a profile, wherein the plurality of multimedia content may be accessed through at least one of a purchase and a subscription; providing a Bellgoo platform connected to the one-world platform, wherein the Bellgoo platform is configured to provide group interactions through multiple interaction configurable modalities; providing an anti-piracy module configured to prevent the distribution, streaming and viewing of unsubscribed and pirated content over the one-world platform; producing an electronic representation of a predetermine portion of the plurality of multimedia content for simultaneous consumption by a predetermined portion of the plurality of users; prompting each user to share commentary on the predetermined portion of the plurality of multimedia content via the user interface; and transmitting the commentary to a predetermined portion of the plurality of users.

In yet another aspect of the present invention, a method of collaboratively promoting and consuming a plurality of multimedia content comprises: providing a one-world platform configured to provide access to the plurality of multimedia content to a plurality of users having a profile, wherein the plurality of multimedia content may be accessed through at least one of a purchase and a subscription, and wherein the one-world platform further provides a user database to facilitate the registrations and maintenance of the profiles of the plurality of users; providing a Bellgoo platform connected to the one-world platform, wherein the Bellgoo platform is configured to provide group interactions through multiple interaction configurable modalities, wherein the Bellgoo platform comprises: a plurality of virtual theatres configured to allow the plurality of users to play, create and schedule a mixed interactive and participatory environment, whereby the plurality of multimedia content serves as a common reference point, and wherein the plurality of virtual theatres are configured to host grand premieres of newly released multimedia content for the plurality of users; and a marketing layer providing at least one of an in-platform advertisement, a sponsorship, a product placement and a merchandising modality; providing an anti-piracy module configured to prevent the distribution of pirated content over the one-world platform; simultaneously consuming a predetermined portion of the plurality of multimedia content over the one-world platform on the part of the plurality of users, whereby scheduling of group view by the plurality of user is promoted; and sharing commentary on the predetermined portion of the plurality of multimedia content part over the Bellgoo platform on the part of the plurality of users, whereby a single international approach to the creation and consumption of the multimedia content is globally conceived.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a schematic view of an exemplary embodiment of the present invention and a continuation of FIG. 1.

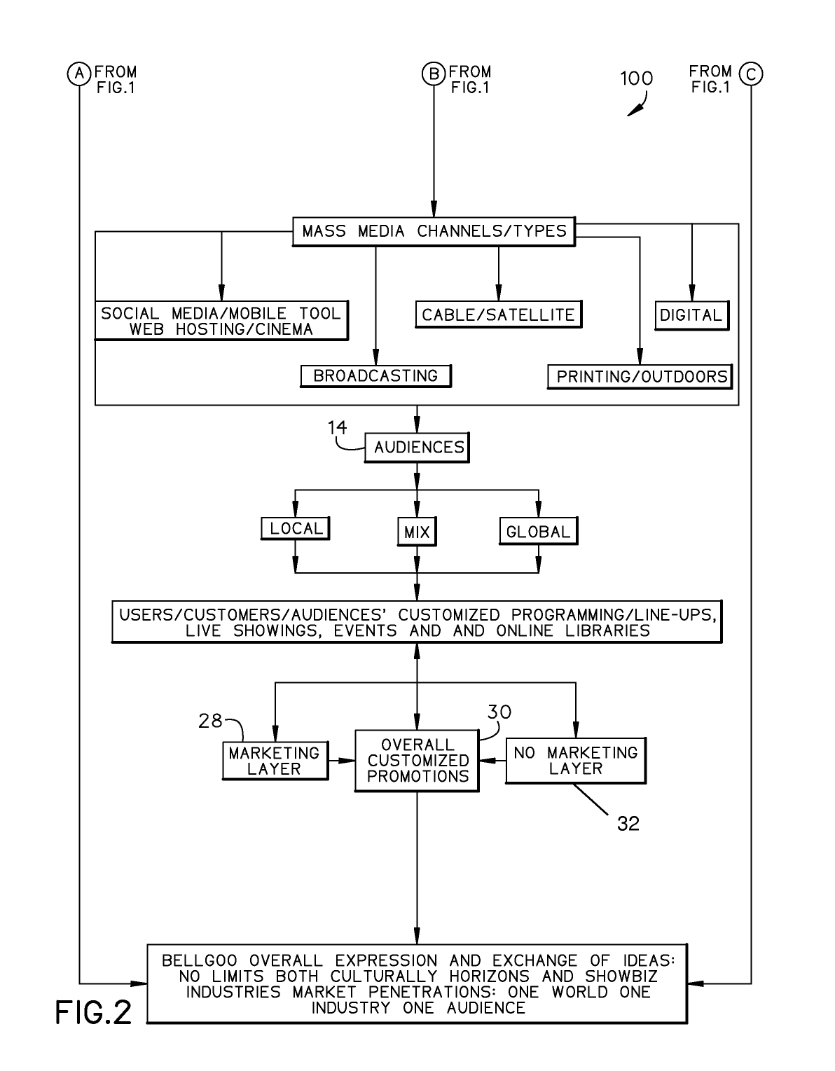

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of collaboratively promoting and consuming a plurality of multimedia content comprising: providing a one-world platform configured to provide access to the plurality of multimedia content to a plurality of users having a profile, wherein the plurality of multimedia content may be accessed through at least one of a purchase and a subscription; providing a Bellgoo platform connected to the one-world platform, wherein the Bellgoo platform is configured to provide group interactions through multiple interaction configurable modalities; providing an anti-piracy module configured to prevent the streaming/viewing of unsubscribed lineups released and/or distribution of pirated content over the one-world platform; simultaneously consuming a predetermined portion of the plurality of multimedia content over the one-world platform on the part of the plurality of users, whereby scheduling of group view by the plurality of user is promoted; and sharing commentary on the predetermined portion of the plurality of multimedia content part over the Bellgoo platform on the part of the plurality of users.

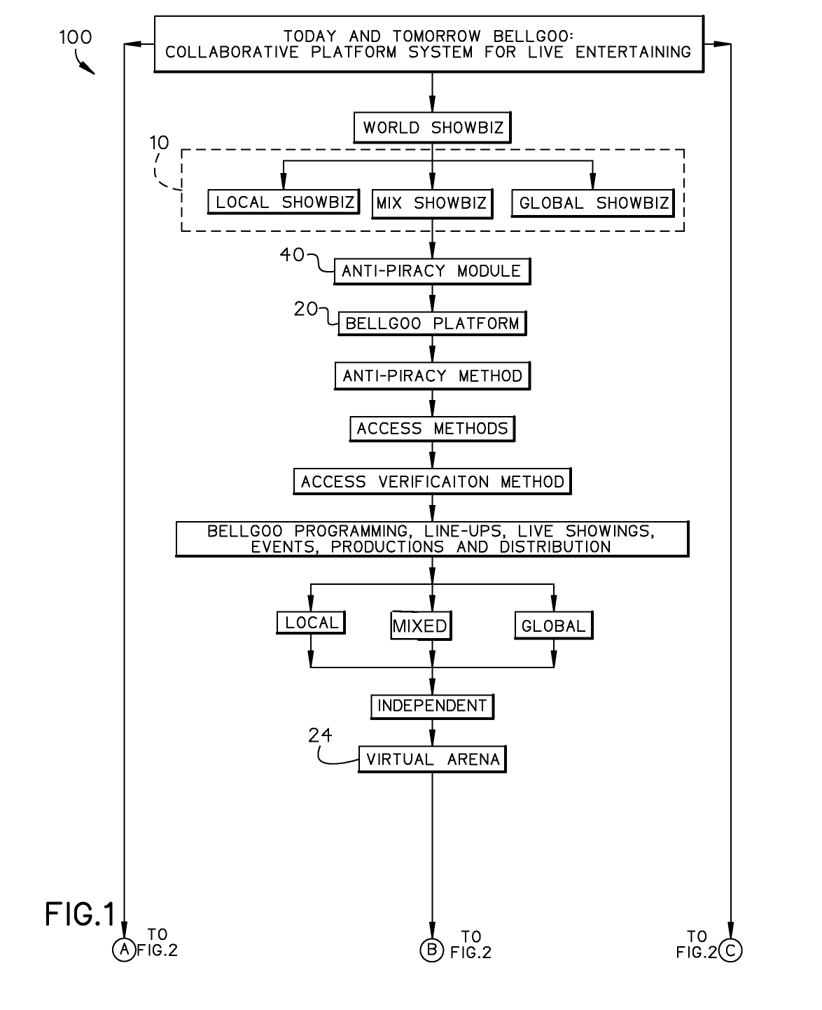

Referring now to FIG. 1, the present invention may include a Bellgoo platform system 100. The Bellgoo platform system 100, which addresses the above-mentioned needs, propagates by layering the world, the independent showbiz, and users into three (3) meaningful groups: 1. Local, 2. Mixed and 3. Global. 1. Local group focuses mainly on local entertaining activities or events. Media content that have focus mainly on an exact local showbiz—the native one, are local. Hollywood, for instance, is the local American showbiz. Bollywood, in India, is the local of the Hindi language film industry, etc.; 2. Mixed (or Mix) group includes not only local entertaining, but also any other foreign showbiz activities: different international lineups and entertaining events it own channels, streaming devices or through partners. Media content which aim to hub interest in any overseas (remote) showbiz other than their local one—the native one; and 3. Global makes a more cosmopolitan approach to the sphere of showbiz particularly and to the large-scale culture in general. Media content which expand interest in exploring the international showbiz in a large-scale, are global. Taking into account the legal conditions that may affect their likely penetration in countries, companies expand beyond borders. Netflix, for instance, is operating in several countries in Europe and elsewhere and recent has mused on expanding in France.

The Bellgoo platform system 100 may include at least one computer with a user interface. The computer may include any computer having at least one processor and a form of memory, including, but not limited to, a desktop, laptop, and smart device, such as, a tablet and smart phone. The computer includes at least one program product including a machine-readable program code for causing, when executed, the computer to perform steps. The program product may include software which may either be loaded onto the computer or accessed by the computer. The loaded software may include at least one application on a smart device. The software may be accessed by the computer using a web browser. The computer may access the software via the web browser using the Internet, extranet, intranet, host server, internet cloud and the like.

The Bellgoo platform system 100 may include a one-world platform 10, a user database 14, a Bellgoo platform 20, and an anti-piracy module 40. The user database 14 may maintain a record of all registered users on the one-world platform 10. Users, in that user database 14, as aforesaid are layering in three (3) distingue and meaningful groups: 1. Local, 2. Mixed and 3. Global. 1. A user with interest only in American movies, music, sporting events, etc. is a local to the American showbiz or culture. 2. A user who aims to hub interest in any overseas (remote) showbiz other than his/her local one—the native one, is a Mixed. Millions of immigrants, descendants of immigrants currently live outside their country of origin. However, they may stay connected to their roots remotely. The soldiers sent fighting abroad, the diplomatic corps, business people traveling all the time, and international students who study abroad, etc. may nurture strong interests in both their country and their living country showbiz and culture. They may be in the mixed group. 3. A user who expand him/her interest in exploring the international showbiz in a large-scale, is a global. Examples are: A cosmopolite or anyone else with an eclectic approach of style and living, athletes, musicians, Researchers, students—specifically Visual and performing arts, languages, literatures and interdisciplinary (students) may be a global. Each individual user of the one-world platform 10 may provide it with a plurality of account information including, but not limited to, a login name, electronic mail (e-mail) address, password, demographic information and the like. The plurality of account information may be stored in the user database 14. The user database 14 may further maintain the plurality of account information e.g., in the form of a profile, for users who log into the one-world platform 10. The plurality of account information may be retrieved from the user database 14 in response to user requests, subject to restrictions of the anti-piracy module 40.

The one-world platform 10 may allow users remote access to on-demand multimedia content before they even hit the shelves through the use of all kinds of possible channels and digital methods of distribution. Such multimedia content may include movies, videos, games, music, cultural, academic, sporting events, social media networks, cable channels, satellite channels, and the like. The one-world platform 10 may allow people the opportunity to build their online library, start their movies stream at any desired time by themselves or collaboratively with other users, and watch across all known media and digital devices without geographical limitations.

The Bellgoo platform 20 may enable group interactions among the users using multiple interaction configurable modalities including but not limited to chat messages, bubble messages, texting, tweeting, user icons, graphical user interface widgets, interactable objects, and the like.

The Bellgoo platform 20 may be a stand-alone streaming service that is not linked to a cable or satellite-provider subscription, because it has its own programming, line-ups, productions and distributions, etc. Bellgoo is to work and constantly explore new innovative models too with its partners. Bellgoo may be access through its own channels and Streaming (stick) Devices or through partners' cable, satellite subscriptions and Streaming (stick) Devices: Chromecast, Roku, Amazon Fire TV, Apple TV, Vudu Spark, etc. As a result, the Bellgoo platform 20 engenders “the online library idea.” Because it embraces and promotes easy access to new releases (New Movies/Films, music, games, videos, sportive events, etc.) to everyone, everywhere, anytime (whenever) through the use of all kinds of possible channels (digital methods) of distribution. It is simple: People directly purchase new movies, video games, etc. for cheap on a one time, monthly, seasonal and/or annually basis. The international and operational approach of movie making, movie watching and movie screens “One-world, One-movie/film-industry, One-audience” is a game changer. It is one thing that makes my method not only different from, but mainly better than any other past, current and possibly future methods. This complex, but easy approach, once well-implemented will pave the way to a unique global conception or international operational approaches of movie making, movie watching and movie screening, and live entertaining experience. This also is true for video gaming, sporting, music, performing events particularly and everything that deals with the imaginations, entertainments, arts along with today's technologies and globalization concept in general. These will both increase tremendously the growth of the American and the worldwide film industry. This international approach is just a new avenue for Hollywood to generate more revenue, reduce spending on anti-piracy laws: fewer dollars on political donations and lobbying, legal fees and fights.

The Bellgoo platform 20 may include a plurality of virtual theatres 24. The virtual theatres 24 may allow users to plan, create and schedule a mixed, interactive and participatory environment with multimedia serving as a common reference point—community interaction during collaborative multimedia consumption in the form of virtual theatres.

The Bellgoo platform 20 may provide a marketing layer 28. The marketing layer 28 may provide in-platform advertisements to the users, enabling in-platform advertisements, sponsorships, product placement, merchandising, and the like to be targeted to users. The Bellgoo platform 20 may provide a no marketing layer 32 free of commercials or advertisements.

The marketing layer 28 may include applications for sponsors and promoters to create and manage at least one virtual, customized promotion 30. The customized promotion 30 may include a virtual interaction platform where users can interact in real time with promotional events, such as a gathering of movie stars, release parties and the like.

The anti-piracy module 40 process may prevent the distribution of pirated content over the one-world platform 10. The anti-piracy module 40 may be important for security purposes, in order to combat piracy without the need for censoring legislation and outrageous legal penalties, while smartly and safely competing with pirated content. In certain embodiments, anti-piracy module 40 may be responsible for granting user access to the one-world platform 10. The anti-piracy module 40 may validate the user's credentials, and logs the user in to the one-world platform 10.

The Bellgoo platform system 100 disclosed above allows the general public full access to New Movies (video)-on-demands based cinema, videos, games, music, sporting events anytime and anywhere instantaneously and interactively without leaving the comfort of their home/location is not currently available. As opposed to the current system which tends to hurt a large percentage of people who cannot leave their home/location, hospital bed, etc. to physically go to the movies, sporting events, etc. or/and families, friends, students, co-workers the privilege to plan and schedule live and instantaneous viewing, seeing and or listening together. The present invention promotes innovation and fully embraces today's technologies. It integrates in purchasing or subscribing all the social media networks/channels, movies, cable channels and/or satellite channels, Streaming (stick) Devices: Chromecast, Roku, Amazon Fire TV, Apple TV, Vudu Spark, etc.; in order to reach out to people everywhere, anytime and instantaneously. It allows people to experience live interactions and strong connections from far distance in the comfort of their own respective location/home in a virtual (movie) theater. People specifically don't have to wait a longtime to watch old Movies (video)-on-demands, pay-per-view old programs, buy or rent DVDs and Bluray and/or online steaming.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, Streaming (stick) Devices, or computer. It is further contemplated that the present invention may be run on a stand-alone computer system, may be run from a server computer system, or a stand-alone streaming service working with its partner so as to be accessed by a plurality of client computer systems interconnected over an intranet network, or that is accessible to clients over the Internet. In certain embodiments, the present invention may be accessible through its own channels and Streaming Devices, partners' cable, satellite subscriptions and Streaming (stick) Devices: Chromecast, Roku, Amazon Fire TV, Apple TV, Vudu Spark, etc. In addition, many embodiments of the present invention have application to a wide range of industries. To the extent the present application discloses a system, the method implemented by that system, as well as software stored on a computer-readable medium, Streaming Devices, or the like and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of collaboratively promoting and consuming a plurality of multimedia content comprising:
providing a one-world platform configured to provide access to the plurality of multimedia content to a plurality of users having a profile, wherein the plurality of multimedia content may be accessed through at least one of a purchase and a subscription;
providing a Bellgoo platform connected to the one-world platform, wherein the Bellgoo platform is configured to provide group interactions through multiple interaction configurable modalities;
providing an anti-piracy module configured to prevent the distribution, streaming and viewing of unsubscribed and pirated content over the one-world platform;
simultaneously consuming a predetermined portion of the plurality of multimedia content over the one-world platform on the part of the plurality of users,
thereby scheduling of group view by the plurality of user is promoted; and
sharing commentary on the predetermined portion of the plurality of multimedia content part over the Bellgoo platform on the part of the plurality of users,
whereby providing real time group interactions and social consumption of live entertainment by users through multiple communications channels and/or interactions.

2. The method of claim 1, wherein the predetermined portion of the plurality of multimedia content part comprises video games, and further providing collaboration on the part the plurality of users in the participation and design of said video games,
whereby a single international approach to the creation and consumption of the multimedia content is globally conceived.

3. The method of claim 1, wherein the Bellgoo platform comprises a plurality of virtual theatres configured to allow the plurality of users to play, create and schedule a mixed interactive and participatory environment, whereby the plurality of multimedia content serves as a common reference point,
thereby engendering community interactions during real-time, instantaneous and incessant collaborative multimedia consumption in the form of the plurality virtual theatres settings.

4. The method of claim 3, wherein the plurality of virtual theatres are configured to host grand premieres of newly released multimedia content for the plurality of users.

5. The method of claim 1, wherein the Bellgoo platform comprises a marketing layer providing at least one of an in-platform advertisement, a sponsorship, a product placement and a merchandising modality.

6. The method of claim 1, wherein the one-world platform further provides a user database to facilitate the registrations and maintenance of the profiles of the plurality of users.

7. A system for collaboratively promoting and consuming a plurality of multimedia content, comprising:
a computer having a user interface; and
a program product comprising machine-readable program code for causing, when executed, the computer to perform the following process steps:
providing a one-world platform configured to provide access to the plurality of multimedia content to a plurality of users having a profile, wherein the plurality of multimedia content may be accessed through at least one of a purchase and a subscription;
providing a Bellgoo platform connected to the one-world platform, wherein the Bellgoo platform is configured to provide group interactions through multiple interaction configurable modalities;
providing an anti-piracy module configured to prevent the distribution of pirated content over the one-world platform;
producing an electronic representation of a predetermine portion of the plurality of multimedia content for simultaneous consumption by a predetermined portion of the plurality of users;
prompting each user to share commentary on the predetermined portion of the plurality of multimedia content via the user interface; and
transmitting the commentary to a predetermined portion of the plurality of users.

8. A method of collaboratively promoting and consuming a plurality of multimedia content comprising:
providing a one-world platform configured to provide access to the plurality of multimedia content to a plurality of users having a profile, wherein the plurality of multimedia content may be accessed through at least one of a purchase and a subscription, and wherein the one-world platform further provides a user database to facilitate the registrations and maintenance of the profiles of the plurality of users;
providing a Bellgoo platform connected to the one-world platform, wherein the Bellgoo platform is configured to provide group interactions through multiple interaction configurable modalities, wherein the Bellgoo platform comprises:
a plurality of virtual theatres configured to allow the plurality of users to play, create and schedule a mixed interactive and participatory environment, whereby the plurality of multimedia content serves as a common reference point, and wherein the plurality of virtual theatres are configured to host grand premieres of newly released multimedia content for the plurality of users; and
a marketing layer providing at least one of an in-platform advertisement, a sponsorship, a product placement and a merchandising modality;
providing an anti-piracy module configured to prevent the distribution of pirated content over the one-world platform;
simultaneously consuming a predetermined portion of the plurality of multimedia content over the one-world platform on the part of the plurality of users,
whereby scheduling of group view by the plurality of user is promoted; and
sharing commentary on the predetermined portion of the plurality of multimedia content part over the Bellgoo platform on the part of the plurality of users,
whereby a single international approach to the creation and consumption of the multimedia content is globally conceived.
